(19) United States
(12) Patent Application Publication
(10) Pub. No.: US 2012/0108429 A1
(43) Pub. Date: May 3, 2012

(54) SAFENED AND EFFICACIOUS WEED CONTROL PARTICLE

(75) Inventors: Charles W. Anderson, Bowling Green, OH (US); Timothy D. Birthisel, Perrysburg, OH (US); James R. Lynch, Toledo, OH (US); Joe Schalk, Maumee, OH (US)

(73) Assignee: The Andersons, Inc., Maumee, OH (US)

(21) Appl. No.: 13/284,303

(22) Filed: Oct. 28, 2011

Related U.S. Application Data
(60) Provisional application No. 61/407,816, filed on Oct. 28, 2010.

(51) Int. Cl. A01N 43/84; A01N 43/88; A01P 13/00; A01N 43/38

(52) U.S. Cl. 504/130; 504/138

(57) ABSTRACT

A weed control particle is provided that includes a delivery granule having a surface and a core. A dicarboximide herbicide is adhered to the surface, mixed into the core of the granule, or both. A dinitroaniline herbicide is adhered to the surface, mixed into the core of the granule, or both. A process of weed control includes distributing such particles or two separate types of particles that each have one of the two types of herbicides to a plot around a desired plant. The weed control particles are distributed at a density such that said dicarboximide herbicide is present at between 20% and 80% of full rate for the dicarboximide herbicide and the dinitroaniline is present at between 20% and 70% of full rate for the dinitroaniline herbicide to provide weed control around the desired plant.

### RELATED APPLICATIONS

This application claims priority benefit of U.S. Provisional Application Ser. No. 61/407,816 filed 28 Oct. 2010; the contents of which are hereby incorporated by reference.

### FIELD OF THE INVENTION

The present invention in general relates to an herbicide particle and in particular relates to a particle simultaneously delivering two synergistic herbicides that are effective in weed control and also reduce chemical burning of the target plant.

### BACKGROUND OF THE INVENTION

As there is a growing recognition that a granular product does not suffer from drift and is less likely to be subject to inadvertent human or animal exposure, there exists a need to formulate a dicarboximide herbicide into a granule form that is effective for weed control. Unfortunately, these herbicides, including the well-known herbicide flumioxazin, have a degree of toxicity against certain ornamental plants and crops. In the case of flumioxazin, ornamental plants such as pentas and hemerocallis are inhibited from properly growing through the application of the herbicide. In recognition that these herbicides when delivered in liquid form can have undesirable side effects that inhibit a desired crop, granular versions of flumioxazin that are amenable to particle broadcast around the crop are known to reduce the toxic effects to the desirous crop plants yet at the expense of weed control.

There also exists a need for formulating dicarboximide herbicides and in particular flumioxazin in a form that reduces the phytotoxic properties of these herbicides toward certain crop plants and in particular ornamental crops.

### SUMMARY OF THE INVENTION

A weed control particle is provided that includes a delivery granule having a surface and a core. A dicarboximide herbicide is adhered to the surface, mixed into the core of the granule, or both. A dinitroaniline herbicide is adhered to the surface, mixed into the core of the granule, or both.

A process of weed control includes distributing such particles to a plot around a desired plant. The weed control particles are distributed at a density such that said dicarboximide herbicide is present at between 20% and 200% of full rate for the dicarboximide herbicide; and the dinitroaniline is present at between 20% and 200% of full rate for the dinitroaniline herbicide to provide weed control around the desired plant.

A process of weed control includes distributing a first type of weed control particles, with dicarboximide herbicide adhered to the surface, mixed into the core, or both. Contemporaneously, a second type of weed control particle is distributed to the plant area that has a dinitroaniline herbicide adhered to the surface, mixed into the core, or both of the second type of particle to a plot around the desired plant. The two types of particles are distributed at a density such that said dicarboximide herbicide is present at between 20% and 200% of full rate for the dicarboximide herbicide; and the dinitroaniline is present at between 20% and 200% of full rate for the dinitroaniline herbicide to provide weed control around the desired plant.

### BRIEF DESCRIPTION OF THE DRAWINGS

The present invention is detailed with respect to the following data presented in graphical form. These figures are intended to be exemplary of the formulations and operation of the present invention and not intended to be a limit upon the practice thereof or the appended claims.

FIG. 1 is a bar graph of weed control for various inventive and control applications at 30-day intervals as measured against an arbitrary scale of 0 to 10, with 10 being complete weed eradication; and

FIG. 2 is a bar graph plot for the formulations of FIG. 1, 90 days after treatment for toxicity relative to the plant types of viburnum, truja, pentas, and hemerocallis as measured against a scale of 0 to 10, with 10 being complete lethality toward the crop plant.

### DETAILED DESCRIPTION OF THE PREFERRED EMBODIMENTS

The present invention has utility as a weed control particle that provides weed control while limiting deleterious effects to crop plants exposed thereto. By providing a delivery granule that includes a dicarboximide herbicide in combination with a dinitroaniline herbicide, the quantity of dicarboximide herbicide needed for weed control is reduced along with phytotoxicity to target crops, along with persistence and crop uptake of the herbicides. Even in instances when overall weed control is reduced relative to full rate liquid application, the benefits of the present invention outweigh the decrease in weed control. To preclude plant absorption or translocation, preferably, an inventive particle is devoid of a surface tackifier or other substrate that might preclude broadcast contact with the soil.

Preferably, inventive herbicide granules are used to control broadleaf weeds by inhibiting weed emergence. It is appreciated that the timing of inventive granule distribution should be consistent with the relative timing of a given crop. Preferably, the rate of dicarboximide herbicide is present at between 20% and 80% of full rate for the dicarboximide herbicide and the dinitroaniline is present at between 20% and 80% of full rate for the dinitroaniline herbicide. Crops illustratively include alfalfa, asparagus, celery, cole crops, corn, carrots, cotton, cucurbits, flax, grain sorghum, turnips, hops, mustard, onions, peas, peanuts, pepper, rapeseed, safflower, wheat, barley, soybeans, sugar beets, sugarcane, tomato, apples, blueberry, cherry, citrus, olives, peach, pears, prunes, tree nuts, vines, sunflower, potato, tobacco, clover, arborvitae, ash, birch, cedar, crabapple, cottonwood, cypress, dogwood, elm, eucalyptus, ficus, fir, ginko, hemlock, lilac, magnolia, maple, oak, mulberry, pines, plum, popular, redbud, spruce, sumac, sweetgum, sycamore, yew, abelia, acacia, azalea, barberry, bayberry, bottlebruch, boxwood, camelia, cotoneaster, cinquefoil, myrtle, english ivy, euonymous, firethorn, forsythia, gardenia, heath, holly, honeysuckle, juniper, loeander, pachysandra, pieris, privet, rhododendron, rose, viburnum, and weigela.

An inventive weed control particle typically has a diameter of between 20 and 500 microns. A delivery granule represents any number of conventional granules conventional to the industry and is either monolithic or composed of aggregate held together with a binder. Optional additives to such a granule illustratively include dust suppression additives, fertilizer particulate, soil nutrients, amendment materials, biostimulants, UV light blockers, solvents, and/or adjuvants.

The delivery granule of an inventive particle is readily formed from cellulosic particulate, inorganic substances, or in the instance of an aggregated delivery granule for an inventive particle, a combination thereof. Illustrative cellulosic materials illustratively include grain flours, wood flour, cereal grain husks, corncob, peanut hulls, and ash or biochar. Inorganic aggregates from which a delivery granule is formed illustratively include silica, slate lime, calcium carbonate, clays, and various minerals such as limestone. A representative granule and methodology for producing the same is detailed in US 2007/0082821 paragraphs [0011]-[0036]. Preferably, a delivery granule is selected as to size and density to promote broadcast distribution such that the vast majority of the delivery granules contact the soil surrounding the desired plant, as opposed to residing on the desired plant. Factors favorable for preferential soil contact include higher densities that are typically in excess of 28 pounds per cubic foot and an overall delivery granule size of between 20 and 4000 microns. Preferably, the delivery granule is an aggregate held together with a binder that promotes fragmentation and integration into soil. A delivery granule optionally includes a foaming agent as detailed in U.S. Pat. No. 7,658,948 to promote active granule dispersion of the herbicides associated therewith to a soil volume that is several times larger than the granule diameter.

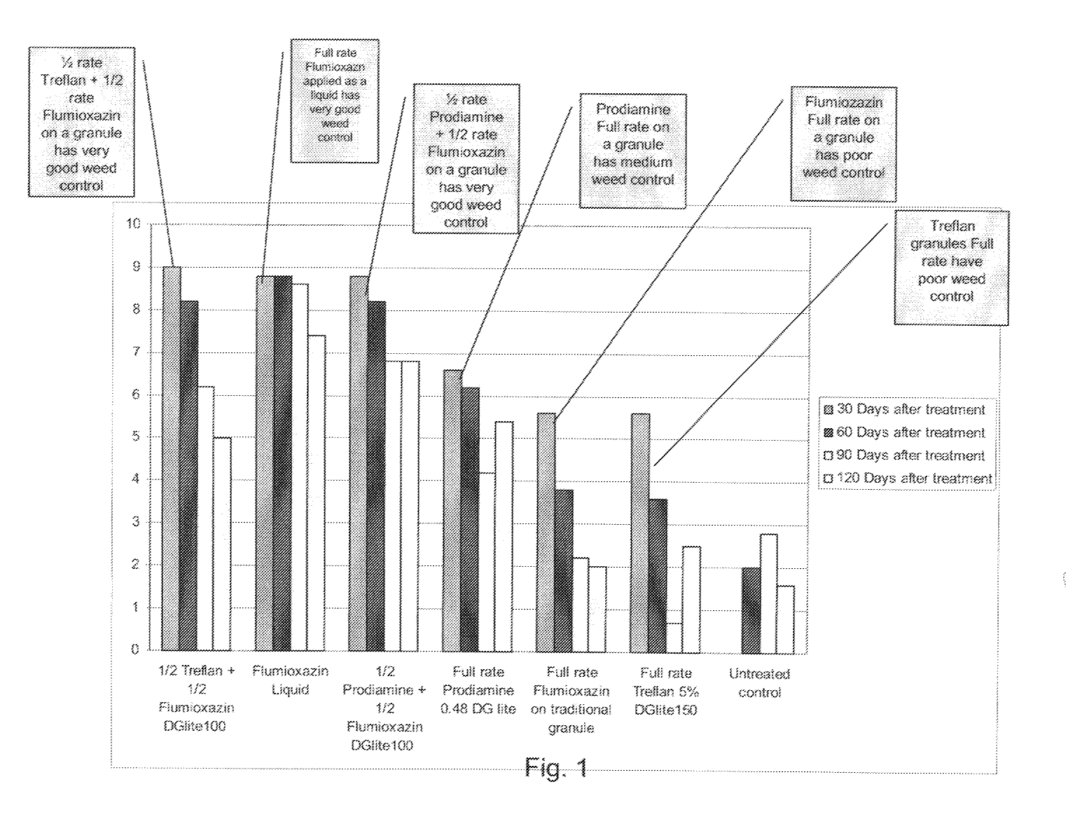

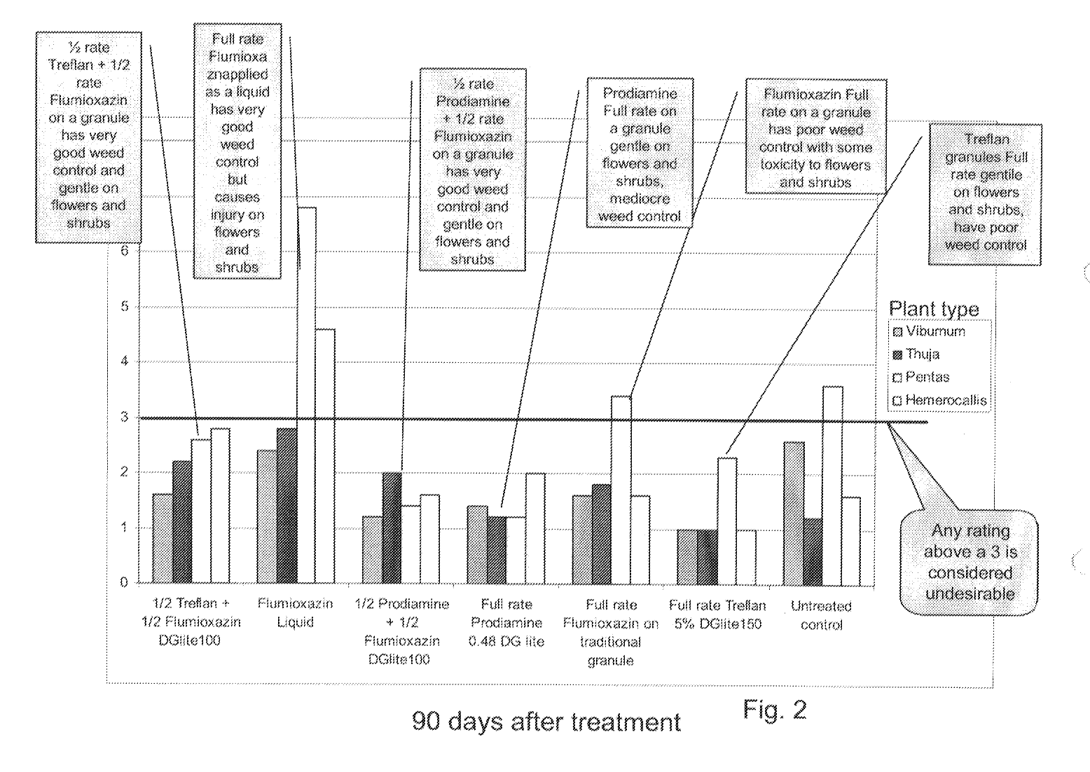

An inventive delivery granule includes a dicarboximide herbicide that is adhered to the surface of the delivery granule, mixed into the volume of the delivery granule in instances when the delivery granule is an aggregate, or a combination thereof. Dicarboximide herbicides operative herein illustratively include cinidon-ethyl, flumezin, flumiclorac, flumioxazin, and flumipropyn, each alone or in combination. As the following data shows for the dicarboximide herbicide flumioxazin delivered on a 1 millimeter dispersible delivery granule at full rate concentrations, the flumioxazin alone delivered on a granule shows poor weed control, FIG. 1 and also exhibits toxicity toward certain desirable plants, as shown in FIG. 2.

The present invention is premised on the surprising result that the simultaneous delivery of a dicarboximide herbicide on a delivery granule with a dinitroaniline herbicide affords effective weed control to a desired plant while limiting toxicity to the desired plant. Dinitroaniline herbicides operative herein include benfluralin, butralin, chlornidine, dinitramine, dipropalin, ethalfluralin, fluchloralin, isopropalin, methalpropalin, nitralin, oryzalin, pendimethalin, prodiamine, profluralin, and trifluralin. From simultaneous delivery of the dicarboximide herbicide and dinitroaniline herbicide on a single delivery granule or temporally proximate delivery of a first particle having the dicarboximide herbicide and a second particle containing the dinitroaniline herbicide, weed control is achieved for desired plants while inhibiting toxicity to those plants. An additional attribute of the present invention is that the rate of the dicarboximide herbicide and dinitroaniline herbicide is reduced relative to conventional liquid usage of either herbicide alone or either herbicide delivered singly on a granule.

As used herein, “full rate” with respect to an herbicide delivery is defined as a term of art recognized to mean nominal EPA label rate.

In contrast to the prior art, the present invention utilizes the dicarboximide herbicide at between 20% and 200% of full rate for the dicarboximide herbicide on a granule and the dinitroaniline is present at between 20% and 200% of full rate on a granule for the dinitroaniline herbicide to provide weed control around the desired plant. Preferably, the rate is between 20% and 80% of full rate and preferably between 40% and 60% of full rate. The dinitroaniline herbicide is used in the present invention at a rate of between 20% and 80% of full rate and preferably between 40% and 60% of full rate. More preferably, both herbicides are used at less than 60% of full rate, and more preferably still, at less than 50% of full rate. By way of example, the dicarboximide is added to soil in an amount of 14 to 56 milligrams per square meter; and the dinotroaniline is added to soil in an amount of 28 to 1112 milligrams per square meter in combination.

The present invention is further illustrated with respect to the following non-limiting examples which are intended to illustrate specific embodiments of the present invention but not otherwise limit the scope of the appended claims.

### Example 1

Commercially available limestone based aggregate granule particles sold under the trade name DGLite® 150 (The Andersons, Maumee, Ohio) are coated with crop oil or other EPA approved solvent solutions containing 0.125% total weight percent of flumioxazin, prodiamine (0.24%), or trifluralin (2.5%), or a combination thereof. The solvents were then adsorbed to produce stocks of DGLite® granules containing: (a) 0.48 total weight percent of prodiamine, (b) 5 total weight percent trifluralin, (c) 0.125 total weight percent flumioxazin plus 0.24 total weight percent prodiamine, and (d) 0.125 total weight percent flumioxazin plus 2.5 total weight percent trifluralin. The resultant particles along with conventional liquid spray of flumioxazin, prodiamine, and trifluralin are applied to 1.2 meter by 1.8 meter random plots 1 days after planting one of: viburnum, truja, pentas, and hemerocallis at rates of either full rate for the individual herbicides, half rate for the individual herbicides, or half rate for each of a synergistic inventive combination of herbicides. An untreated control plot was also provided and weed growth in the plots was measured at 30-day intervals for 120 days. The results are plotted in FIG. 1 against a 10-point scale where 10 denotes 100% control and 0 on the scale denotes 0% control. The inventive combination granules containing flumioxazin and prodiamine or flumioxazin and trifluralin all delivered at 50% of full rate provide weed control comparable to prior art liquid spray of flumioxazin and superior weed control relative to each of the individual herbicides delivered individually and alone on a carrier granule.

The test plots are also monitored for toxicity to desired plants within the test plots. The toxicity for the plots depicted in FIG. 1 for various desired plant plots at 90 days is shown in FIG. 2 where 10 on this scale denotes complete plant death while 0 denotes 100% healthy plant. The horizontal line in FIG. 2 at 3 on the toxicity scale constitutes an industry-acceptable level of desired plant toxicity. The inventive synergistic combination particles in addition to achieving satisfactory weed control do so with reduced toxicity to the desired plants.

### Example 2

Field trials are repeated with the simultaneous broadcast distribution of DGLite® 150 granules coated with either flumioxazin or prodiamine. Single herbicide granules are simultaneously broadcast onto plots at 40% of full rate for each herbicide to achieve results comparable to a single granule loaded with 0.125 total weight percent flumioxazin and 0.24 total weight percent prodiamine.

### Example 3

The composition of Example 1 is applied to test plots in late June in a randomized filed of test plots, each measuring 8×30 feet. The test plots are uniformly seeded with chenopodium album (common lambsquarters), cirsiium anvense (Canada thistle), digitaria sanguinalis (large crabgrass), echinochioa crus-gali (common berryardgrass), panicum dichotomiflorun Michx (fall panicum), persicaria Pennsylvania (Pennsylvania smartweed), and portulaca oleracae (common purslane)/Weed emergence and growth as a percentage of seeds planted is measured. The granule particles containing 0.125% total weight percent flumioxazin and 2.5% total weight percent trifluralin exhibit weed control values of 8.3, 7.6, and 6.9 at 8, 10, and 12 weeks; respectively at 50% of a recommended rate application per area. This compared to 8.9, 8.5, and 8.6 for 100% rate liquid spray flumioxazin and trifluralin at 8, 10, and 12 weeks; respectively that is watered into the soil. Soybean growth rates for the inventive particles are improved relative to the conventional liquid spray, indicating that the flumioxazin toxicity is reduced, while total herbicide usage is decreased.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof The following claims, including all equivalents thereof, are intended to define the scope of the invention.

1. A weed control particle comprising:
a delivery granule having a surface and a core;
a dicarboximide herbicide adhered to the surface, mixed into the core, or a combination thereof and
a dinitroaniline herbicide adhered to the surface, mixed into the core, or a combination thereof.

2. The particle of claim 1 wherein said dicarboximide herbicide is flumioxazin.

3. The particle of claim 1 wherein said dinitroaniline herbicide is trifluralin or prodiamine.

4. The particle of claim 4 wherein said delivery granule is a preformed agglomerate and said dicarboximide herbicide and said dinitroaniline herbicide are only on the surface.

5. The particle of claim 1 wherein said delivery granule has a particle size of between 20 and 500 microns.

6. The particle of claim 1 wherein said dicarboximide herbicide is present in an amount of 14-56 milligrams per square meter of the surface.

7. The particle of claim 1 wherein said dinitroaniline herbicide is present in an amount of 28-1112 milligrams per square meter of the surface.

8. A process for weed control around a desired plant comprising:
distributing a plurality of weed control particles, each of said particles comprising:
a delivery granule having a surface and a core;
a dicarboximide herbicide adhered to the surface, mixed into the core, or a combination thereof; and
a dinitroaniline herbicide adhered to the surface, mixed into the core, or a combination thereof;
to a plot around the desired plant, said plurality of weed control particles distributed at a density such that said dicarboximide herbicide is present at between 20% and 200% of full rate for said dicarboximide herbicide and said dinitroaniline is present at between 20% and 200% of full rate for said dinitroaniline herbicide to provide weed control around the desired plant.

9. The process of claim 8 wherein the desired plant is one of alfalfa, asparagus, celery, cole crops, corn, carrots, cotton, cucurbits, flax, grain sorghum, turnips, hops, mustard, onions, peas, peanuts, pepper, rapeseed, safflower, wheat, barley, soybeans, sugar beets, sugarcane, tomato, apples, blueberry, cherry, citrus, olives, peach, pears, prunes, tree nuts, vines, sunflower, potato, tobacco, clover, arborvitae, ash, birch, cedar, crabapple, cottonwood, cypress, dogwood, elm, eucalyptus, ficus, fir, ginko, hemlock, lilac, magnolia, maple, oak, mulberry, pines, plum, popular, redbud, spruce, sumac, sweetgum, sycamore, yew, abelia, acacia, azalea, barberry, bayberry, bottlebruch, boxwood, camelia, cotoneaster, cinquefoil, myrtle, english ivy, euonymous, firethorn, forsythia, gardenia, heath, holly, honeysuckle, juniper, loeander, pachysandra, pieris, privet, rhododendron, rose, viburnum, or weigela.

10. The process of claim 8 wherein said dicarboximide herbicide is one of cinidon-ethyl, flumezin, flumiclorac, flumioxazin, or flumipropyn.

11. The process of claim 8 wherein said dinitroaniline herbicide is one of benfluralin, butralin, chlornidine, dinitramine, dipropalin, ethalfluralin, fluchloralin, isopropalin, methalpropalin, nitralin, oryzalin, pendimethalin, prodiamine, profluralin, or trifluralin.

12. The process of claim 8 wherein the weed control around the desired plant occurs without toxicity to the desired plant of greater than 30%, 90 days after the distribution.

13. The process of claim 8 wherein said dicarboximide herbicide is delivered at between 40% and 60% of full rate and said dinitroaniline herbicide is delivered at between 40% and 60% of full rate.

14. A process for weed control around a desired plant comprising:
distributing a first plurality of weed control particles, each of said particles comprising a delivery granule having a surface and a core and a dicarboximide herbicide adhered to the surface, mixed into the core, or a combination thereof; and
contemporaneously distributing a second plurality of weed control particles, each of said second plurality of particles comprising a delivery granule having a surface and a core and a dinitroaniline herbicide adhered to the surface, mixed into the core, or a combination thereof;
to a plot around the desired plant, said plurality of weed control particles distributed at a density such that said dicarboximide herbicide is present at between 20% and 80% of full rate for said dicarboximide herbicide and said dinitroaniline is present at between 20% and 70% of full rate for said dinitroaniline herbicide to provide weed control around the desired plant.

15. The process of claim 14 wherein the desired plant is one of alfalfa, asparagus, celery, cole crops, corn, carrots, cotton, cucurbits, flax, grain sorghum, turnips, hops, mustard, onions, peas, peanuts, pepper, rapeseed, safflower, wheat, barley, soybeans, sugar beets, sugarcane, tomato, apples, blueberry, cherry, citrus, olives, peach, pears, prunes, tree nuts, vines, sunflower, potato, tobacco, clover, arborvitae, ash, birch, cedar, crabapple, cottonwood, cypress, dogwood, elm, eucalyptus, ficus, fir, ginko, hemlock, lilac, magnolia, maple, oak, mulberry, pines, plum, popular, redbud, spruce, sumac, sweetgum, sycamore, yew, abelia, acacia, azalea, barberry, bayberry, bottlebruch, boxwood, camelia, cotoneaster, cinquefoil, myrtle, english ivy, euonymous, firethorn, forsythia, gardenia, heath, holly, honeysuckle, juniper, loeander, pachysandra, pieris, privet, rhododendron, rose, viburnum, or weigela.

16. The process of claim 14 wherein said dicarboximide herbicide is one of cinidon-ethyl, flumezin, flumiclorac, flumioxazin, and flumipropyn.

17. The process of claim 14 wherein said dinitroaniline herbicide is one of benfluralin, butralin, chlornidine, dinitramine, dipropalin, ethalfluralin, fluchloralin, isopropalin, methalpropalin, nitralin, oryzalin, pendimethalin, prodiamine, profluralin, or trifluralin.

18. The process of claim 14 wherein the weed control around the desired plant occurs without toxicity to the desired plant of greater than 70%, 90 days after the distribution.

19. The process of claim 14 wherein said dicarboximide herbicide is delivered at between 40% and 60% of full rate and said dinitroaniline herbicide is delivered at between 40% and 60% of full rate.
